(19) United States
(12) Patent Application Publication
(10) Pub. No.: US 2015/0161686 A1
(43) Pub. Date: Jun. 11, 2015

(54) Managing Reviews

(71) Applicants: Kurtis Williams, Fruit Heights, UT (US); Jon Grover, Sandy, UT (US); John Sperry, Sandy, UT (US); Derek Newbold, South Jordan, UT (US)

(72) Inventors: Kurtis Williams, Fruit Heights, UT (US); Jon Grover, Sandy, UT (US); John Sperry, Sandy, UT (US); Derek Newbold, South Jordan, UT (US)

(21) Appl. No.: 13/952,163

(22) Filed: Jul. 26, 2013

(51) Int. Cl. G06Q 30/02

(52) U.S. Cl. CPC G06Q 30/0282

(57) ABSTRACT

Technology is described for managing reviews of organizations. An example method of the technology may identify reviews of an organization sourced from an open review system, the open review system including reviews of unverified customers. Reviews of the organization may be collected from a closed review system which includes reviews of verified customers. The reviews from the closed review system may be reviews which are submitted by organization customers within a predefined period of time prior to a current time and the number of reviews used in the method may exceed a predetermined amount of reviews. The reviews may be converted from the closed review system into converted reviews formatted for the open review system.

### FIELD OF THE INVENTION

The invention relates generally to the field of customer feedback management. Particularly, the invention relates to a system and method for accurately portraying current consumer sentiment regarding goods or services.

### BACKGROUND

Customer feedback management is an increasingly important data tool in an increasing information driven customer management environment. Every interaction a customer has with a company leaves a mark or an impression that they will most likely share with other customers. This experience may or may not be the brand that the company is promoting through its various marketing initiatives and may or may not have a positive impact on customer loyalty. Decision-makers that run and operate businesses use customer feedback to improve customer experiences thereby building loyalty and increasing revenues.

As most modern decision-makers realize, the volume of available information surrounding business decisions is not always helpful. In many cases, decision-makers are forced to rely on myriad disparate sources of information, each having been gathered and structured in its own idiosyncratic way. Moreover, once this information is synchronized, its value and importance for result-driven decision-making is not always optimally or correctly evaluated.

Customer feedback can be collected in numerous ways including web surveys, phone surveys, mobile devices, and social media websites. Internet-based consumer reviews, as one example, have been widely implemented. Consumer reviews can be a useful tool for consumers in making purchasing decisions. Consumer reviews are commonly provided for products and services.

Internet-based consumer reviews of products are often viewed as reliable because variance in product manufacturing is minimal. However, a quality of service from service based organizations may have a greater variance and may thus either be relatively less reliable and/or may be subject to errors and inaccuracies. For example, a service-based organization, such as a restaurant, may be constantly changing in a variety of aspects. Staff members may change during the day as work shifts begin and end, cleanliness of the tables may vary as patrons come and go from the restaurant, staff turnover may involve employees leaving or joining the restaurant workforce, the food served may be changed, atmosphere of the restaurant may be updated, existing staff may receive additional training or experience over time and so forth.

Additionally, many internet-based consumer reviews permit anonymous reviews, which introduce issues of fraudulent reviews. For example, competitors may leave fake, negative reviews, or a company's employees may leave fake, positive reviews. Inaccuracy of reviews, along with the potential for fraud and various other issues can introduce a question of trustworthiness of internet-based consumer reviews, which in turn may lessen the value of the reviews as a tool to consumers or businesses.

### SUMMARY OF THE INVENTION

In light of the problems and deficiencies inherent in the prior art, the present invention seeks to overcome these by providing a system and method for managing the reviews of organizations, their products, or services offered. In one embodiment, the method comprises identifying on-line reviews of an organization sourced from an open review system, the open review system including reviews of unverified customers. The method also comprises collecting reviews of the organization from a closed review system which includes reviews of verified customers, wherein the reviews from the closed review system are submitted by organization customers within a predefined period of time prior to a current time and wherein the number of reviews exceeds a predetermined amount of reviews. The method further comprises converting reviews from the closed review system into converted reviews formatted for the open review system, using a processor.

In another embodiment, the method comprises identifying on-line reviews of an organization sourced from an open review system, the open review system including reviews of unverified customers and collecting reviews of the organization from a closed review system which includes reviews of verified customers, wherein the reviews from the closed review system are submitted by organization customers within a predefined period of time prior to a current time and wherein the number of reviews exceeds a predetermined amount of reviews. The method further comprises converting reviews from the closed review system into converted reviews formatted for the open review system, using a processor.

In another embodiment, a system for managing reviews of service based organizations is provided comprising a review collection module to collect reviews of a service based organization from a closed review system which includes reviews of verified customers of the service based organization, the reviews being based on verified user experiences with the service based organization. The system also comprises a conversion module to convert the reviews from the closed review system into converted reviews using a processor, when the reviews are proximal in time to a current time, within a predetermined threshold, wherein the reviews from the closed review system are submitted by organization customers within a predefined period of time prior to a current time and wherein the number of reviews exceeds a predetermined amount of reviews.

In accordance with another embodiment, a method for managing reviews of service based organizations is provided comprising evaluating whether reviews from an open review system are representative of performance of the service based organization based on a number of the reviews and a proximity in time of the reviews to the present time, using a processor and retrieving closed reviews of the service based organization from a closed review system. The method also comprises converting the closed reviews from the closed review system into converted reviews formatted for the open review system, using the processor, when the reviews are proximal in time to a current time, within a predetermined threshold and publishing the converted reviews to the open review system.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is an illustration of a customer reviews content page in accordance with an example of the present technology.

FIG. 2 is block diagram of a system for managing reviews in accordance with an example of the present technology.

FIG. 3 is a block diagram of a review management system in accordance with an example of the present technology.

FIGS. 4-5 are flow diagrams of methods for managing reviews in accordance with examples of the present technology.

FIG. 6 is block diagram illustrating an example of a computing device for review management in accordance with an example of the present technology.

FIG. 7 is a block diagram of the components of a recommendation engine system in accordance with an example of the present technology.

FIG. 8 is a diagram showing example target vectors projected onto a unit sphere in accordance with an example of the present technology.

FIG. 9 is a diagram showing example predicted vectors compared to the target vectors of FIG. 8.

### DETAILED DESCRIPTION

Reference will now be made to, among other things, the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. Broadly stated, methods and apparatus for collecting and analyzing closed-review consumer survey data within a certain period of time and having a certain minimum number of data points are described.

Customer satisfaction data can be obtained from multiple disparate data sources, including in-store consumer surveys, post-sale online surveys, voice surveys, comment cards, social media, imported CRM data, and broader open market consumer polling, for example.

Several factors are included in determining a composite score or numerical representation of customer satisfaction. Herein, that numeral representation is referred to as a Customer Satisfaction Index (“CSI”) or Primary Performance Indicator (“PPI”). There are a number of other methods for deriving a composite numerical representation of customer satisfaction that are contemplated for use in different embodiments of the present invention. For example, Net Promotor Score (NPS), Guest Loyalty Index (GSI), Overall Satisfaction (OSAT), Top Box, etc. are contemplated for use herein. This list is not exhaustive and many other methods exist to use mathematical methods to derive a numeric representation of satisfaction or loyalty would be apparent for use herein by one ordinary skill in the art.

In whichever manner customer satisfaction data is obtained or scored, such as in the form of consumer reviews, reviews for products and organizations may not be accurate depending on a variety of factors. For example, reviews for organizations such as restaurants and retail may be inaccurate due to how frequently the establishment can change, the low volume of anonymous review sites, and fraud. The present technology enables reviews that can then be trusted by future consumers in making buying decisions.

Many online review sites only show one score which is an aggregate of the customer's overall satisfaction score. Embodiments of the present invention use key driver data to identify a specific area an organization's highest scored area and lowest scored area. This allows the customer more insights into what to expect when they visit the organization without having to read the comments.

Additionally, in certain embodiments of the invention, previous customer feedback is summarized to help consumers make better decisions on where they spend their money, by running all the text comments through an analyzer that pulls out the most common relevant themes by frequency and displays the themes in a word cloud. The customer does not have to read all the comments to make a decision; they only have to view the themes and can then ascertain what other customers say about the organization.

Many online review sites have a small number of reviews for each establishment. A small number of reviews may not provide sufficient data to allow a consumer to accurately assess if the establishment is performing well in key areas. The sample size may be too small, the available reviews may not be recent, the reviews may be fraudulent and so forth.

In the customer feedback industry, many reviewers or reviewed organizations desire anonymous and unshared review data in order for the feedback to be considered genuine or unbiased. If customers feel that their opinions will be shared or somehow identifiable, the customers may give different feedback than if the opinions are anonymous. In some aspects, the emergence and success of social media has changed this perception, but many areas of the customer feedback industry have been slow to respond.

Customer feedback data is commonly gathered privately and analyzed privately. The present technology may involve the public sharing of customer feedback and is capable of using privately collected survey data for repairing public opinion, or more particularly for repairing an inaccurate, negative public opinion.

The present technology may provide for managing reviews, such as reviews of organizations. The organizations may be, for example, service-based organizations. The technology may involve identifying on-line or internet-based reviews of an organization which are sourced from an open review system. As used herein, the phrase “open review system” may refer to any review system to which consumers can submit reviews without verification that the consumer has purchased, used, or otherwise experienced the product or service for which the consumer is submitting the review. An open review system may be contrasted with a “closed review system,” which may refer to a review system to which consumers may submit a review of a product or service after verifying purchase, use or experience of the product or service. “Open reviews” may refer to reviews submitted through an “open review system” and “closed reviews” may refer to reviews submitted through a “closed review system.” Open reviews and closed reviews may be anonymous or non-anonymous.

The technology may identify the reviews sourced from an open review system, such as by using a crawler to search review pages from the open review system for reviews relevant to an organization. Alternately, review pages may be manually identified by a user. In yet another embodiment, the present technology and/or the open review system may provide an application programming interface (API) for communicating between the open review system and a review management system of the present technology, such as to provide notifications of new reviews, to provide access to reviews and so forth. In some examples, the open review system may be a social network, a forum, a public review network page, an internet marketplace and so forth.

The review management system of the present technology may further operate to collect reviews of the organization from a closed review system. The closed review system may optionally be a part of the review management system or may supply the reviews to the review management system. Closed review systems may provide more trustworthy reviews as compared with some open review systems because of the verification process involved. Also, many closed review systems obtain a significantly larger number of reviews than open review systems. The difference in the number of reviews may be attributable to any of a variety of factors, such as marketing, trust, better visibility of the option to submit reviews and so forth.

Because the review management system may have access to reviews from a closed review system, where the number of reviews may be significant, the review management system can filter reviews to provide an accurate assessment of consumer sentiment with regards to the organization without falling below a statistically significant sampling size or without eliminating resorting to reviews which are not proximal in time to the present. In other words, the reviews selected from the closed review system may be those submitted by organization customers within a predefined period of time prior to the current time and the number of the reviews may exceed a predetermined amount or threshold number of reviews. Because the reviews are proximal in time to the present and include an adequate sampling size, the reviews may be considered accurate and may be useful to customers wishing to learn about the organization, or may be useful to the organization in learning about how customers view recent performance of the organization.

Different review systems may include different mechanisms for storing the review data, representing the review data and so forth. For example, some review systems may accept binary ratings (e.g., positive or negative, thumbs up or thumbs down, etc.), numerical ratings (e.g., a score out of 5, 10, 100, etc.), freeform textual ratings (e.g., a text box for receiving any review input from a customer), audio ratings (e.g., a voice recording of customer sentiment regarding service provided, etc.) or any of a number of different types or formats of ratings, or any combination thereof.

Certain embodiments of the invention captures feedback in the customer's own voice using a priority phone survey system. The customer using a phone is allowed to speak their feedback, which is then converted to text, analyzed with text analytics for themes, and then converted into a compressed format for storage. Customers can then listen to the survey applicant's comment.

Because of discrepancies in rating mechanisms from one rating system to another, the present technology may provide for conversion between formats in order to repair reviews of an open review system using the closed reviews. For example, the present system may convert reviews from the closed review system into converted reviews formatted for the open review system. The conversion process will be described in additional detail later.

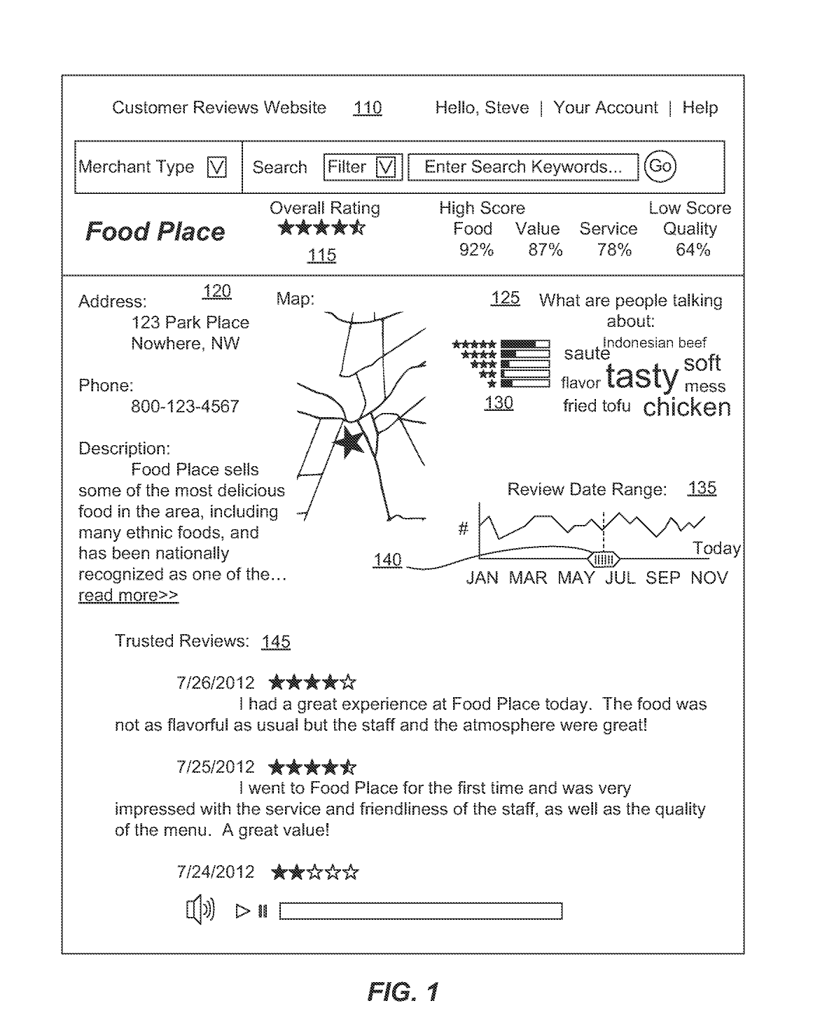

With specific reference to the figures, FIG. 1 is a block diagram illustration of a content page 110 for viewing customer reviews. The content page may enable users to view reviews, enter reviews, manage reviews and so forth. The content page may include options for sorting, searching, filtering and so forth to enable users to access reviews and other information related to a particular organization. The content page may include user account information, or links thereto, to enable users to manage account options, reviews and so forth.

The content page 110 may include various information 120 about a selected organization, such as a name of the organization, address of the organization, phone number for the organization, description of the organization, web address of the organization, an average overall rating of the organization according to user-submitted reviews and so forth. In the example illustrated, other features, such as a map, a breakdown of the ratings resulting in the average overall rating 115, keywords of user-submitted reviews 125, a breakdown 130 of different aspects of the rating of the organization, a timeline 135 including a graph based on the reviews, detailed reviews 145 and so forth may also be provided for display.

The content page 110 illustrated in FIG. 1 may relate to an open or closed review system. In one example, the content page is for a closed review system. Reviews received and managed through the closed review system may be used to rehabilitate a reputation of an organization on an open review system. For example, on-line reviews of the organization sourced from the open review system may be identified and analyzed. If a threshold number of reviews has not been received at the open review system and/or if the reviews include ratings of the organization at less than a predetermined threshold rating level, the system may look to the reviews collected through the closed review system to determine whether additional reviews are available, whether the additional reviews are more proximal in time to the present than the reviews available through the open review system, and/or whether the additional reviews include a higher average rating than the average rating of the reviews available through the open review system. In one aspect, the reviews from the closed review system may be used to rehabilitate the organization reputation on the open review system when a threshold number of reviews are available within a predetermined time period extending back from the present.

Because the reviews of the closed review system and the reviews of the open review system may be formatted differently or include various different types of data as part of the review, the reviews from the closed review system may be converted into converted reviews formatted for the open review system. While some aspects of the conversion process will be described in greater detail later, the conversion may include, for example, a conversion of a score or other quantifiable rating, such as a rating out of 5 stars, a rating on a scale of 1-10 and so forth from one scale or format to another. For example, a rating on a scale of 1-10 may be converted to a scale of 1-4. Text of textual reviews may be extracted and reformatted, summarized, etc. as a conversion of text from a closed review system to an open review system. For example, a lengthy review from the closed review system may be summarized for a shorter word limit imposed at the open review system. As another example, keywords may be extracted from the closed reviews and used as keyword tags for the open review system. Where the closed review system includes additional granularity to the review, such as rating a restaurant by food, value, service, quality and so forth, as illustrated in FIG. 1, any level of granularity may be converted to the open review system. For example, if a review at the closed review system did not include an overall rating, but included a number of more granular sub-ratings, and the open review system allows an overall rating without the additional granularity, then the more granular sub-ratings may be combined or merged into an overall rating suitable for the open review system according to a conversion method, where different sub-ratings may optionally be weighted differently in the conversion.

In converting the reviews from the closed review system to the open review system, a scale rating may be used. For example, if a closed review system review is based on a series of questions, the answers to these questions may be machine-evaluated and converted to a scaled score or scaled rating, such as between 0 and 5 stars. When reviews are converted from one system to another, a notation or indication may optionally be used on or included with the converted review to provide notice to a user that the review has been converted. Optionally, an indication of the pre-conversion review or rating may be provided as a comparison, or information regarding how the conversion was accomplished may be provided.

In one example, reviews may be converted from the closed review system for the open review system multiple times, such as on a periodic basis, at user-define time intervals, and so forth. Converted reviews which are published to the open review system may be kept on the open review system for a predetermined period of time. For example, when converted reviews on the open review system predate the current time by the predetermined period of time then the converted reviews may be purged from the open review system. Similarly, when publishing converted reviews to the open review system, if open review system reviews are available which predate the current time by more than the predetermined period of time, such reviews may be optionally purged. To maintain an honest and accurate system of reviews both positive and negative reviews may be similarly purged, where proximity in time is used to determine whether reviews are relevant. Reviews may also be purged from the closed review system after the predetermined period of time has expired.

The time period used for determining whether to purge any reviews from the open or closed review systems may be any suitable period of time and may vary depending on the type of organization for which the reviews are submitted. For example, reviews of some organizations may be useful for a matter of weeks, others for months, and others for years. As specific examples, the predetermined time period may be three months, six months or one year. Other specific examples may be anywhere from two weeks to two years, including discrete time intervals in that range not explicitly enumerated.

The content page 110 of FIG. 1 may include a timeline 135 and may optionally include a slider 140. The timeline may include a graph illustrating a volume of reviews over a period of time represented by the timeline. In another example, the timeline may include a graph illustrating an average rating provided in the reviews over time. This may enable, for example, a user to identify an overall trend in increase or decrease in quality. In one example, the graph may identify any clear trends for the user to see immediately.

The graph may represent a greater period of time than the period of time used for displaying the current average review. For example, while a full year's worth of reviews may be available, six months of reviews may constitute what is considered representative of the organization currently. An indication may be provided on the graph of what portion of the period of time represented by the graph corresponds to the reviews from which the current rating of the organization is based. For example, the indication may include coloration, shading, a line or any other suitable form of indication. Additionally, the graph may include indicators of scale, including for example, tic marks for periods of time in the past, optionally as measured from the present. The tic marks may be useful in better determining the period of time indicated for inclusion in the rating, such as demarcated by the coloration, shading, line, etc.

The graph may include a slider to enable a user to slide the slider 140 along the graph to see the average rating over a greater or lesser period of time than a default time. In one example, the slider may be used with a timeline without an accompanying graph. As a user slides the slider along the timeline, the average review score may be dynamically modified to correspond to the position of the slider. Other portions of the content page may also be modified dynamically in response to the changing position of the slider, such as the chart illustrating what people are saying about the restaurant, which reviews have been rated most highly during the time period and so forth. Some information may remain the same, such as the name of the organization, the address and so forth. While an organization may have moved at some point during the time period, displaying the previous location when the slider is moved may be potentially confusing to a user. Thus, in one embodiment the content that is modified in response to movement of the slider may be the reviews themselves or any data derived from the reviews.

The slider 140 may be useful for a user wishing to view reviews of an organization or may be used in setting a period of time from which to publish reviews from the closed review system to the open review system. For example, the user may wish to include a greater number of reviews to publish to the open review system, such as if the open review system includes some older negative reviews which are not representative of a majority of customers as determined by the available closed system reviews for that same time period. In such an example, multiple sliders may be used to restrict the time period for publishing the reviews to a period of time in the past and not extending to the present. As another example, the user may wish to include a lesser number of reviews to publish to the open review system, such as if the open review system includes reviews which predate a management or other change and the user wishes to publish the reviews representative of the organization from the time that the management changed.

The graph on the timeline may include, for example, a volume of reviews. In other words, the axes for the graph may include time and a number of reviews. The graph may optionally overlay a volume of reviews from an open review system on the volume of reviews from the closed review system to enable a quick visual comparison that may be useful in determining whether to publish the closed system reviews or that may be useful in determining a likely impact of the publication on the rating of the organization at the open review system. In some examples, publishing reviews from the closed to the open review system may be desirable when the reviews from the closed review system are greater in number than the reviews from the open review system, such as by a predetermined amount, percentage or number of reviews. For example, a minimum number of closed system reviews may be 1,000 or 10,000. The minimum number of closed system reviews may be a minimum number of total reviews for publication to be considered or may be a minimum number of reviews by which the number of closed system reviews exceeds the number of open system reviews. In other examples, the minimum number of closed system reviews may be anywhere from 100 to 100,000, including any discrete numbers within the range not explicitly described, but which are also considered a part of this disclosure.

Some organizations may include multiple branches, stores, locations of operation and so forth. Reviews for such organizations may be managed collectively or on a per-location basis. In one example, reviews from the closed review system for organizations having multiple locations of operation may be aggregated on a per-location basis and a potentially different score or rating may be assigned to each of the multiple locations of operation. In another example, reviews for organizations having multiple locations of operation may be aggregated on an organization-wide basis and a same score or rating may be assigned to each of the multiple locations of operation. In yet another example, reviews for organizations having multiple locations of operation may be aggregated on a per-location basis and a same score or rating may be assigned to each of the multiple locations of operation. In particular, such combination or otherwise of the scores may be performed in combination with conversion of reviews from the closed review system to the open review system, such as to accommodate capabilities or a configuration of the open review system.

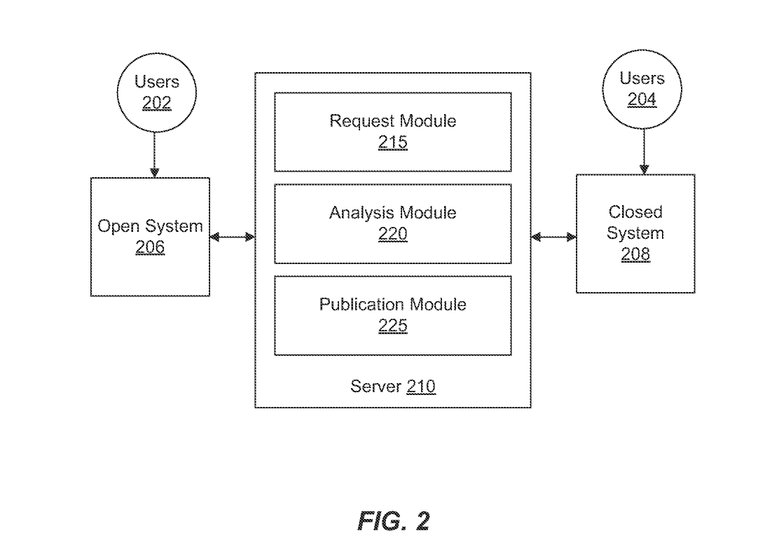

Referring now to FIG. 2, a system for managing reviews is illustrated in accordance with an example. The system enables rehabilitation of reviews at the open review system 206 using reviews from the closed review system 208. The present technology may be at least partially integrated at one or both of the open and closed review systems or may operate independently between two such systems. Users 202, 204 may submit reviews at both the open and closed review systems. A rehabilitation server 210 may request or identify reviews from the open and closed review systems, such as by using a request module 215. An analysis module 220 may be used to make any of a number of determinations, such as whether sufficient reviews are available at the closed review system for rehabilitation to be an option, whether the open review system reviews are few enough in number that rehabilitation is desirable, whether a minimum number of reviews of the open or closed review systems are available which are proximal in time to the present within a predetermined time period, and so forth. Based on results of the analysis performed by the analysis module, the rehabilitation server 210 may publish reviews from the closed review system to the open review system, including performing any conversion to the reviews, such as by using a publication module 225.

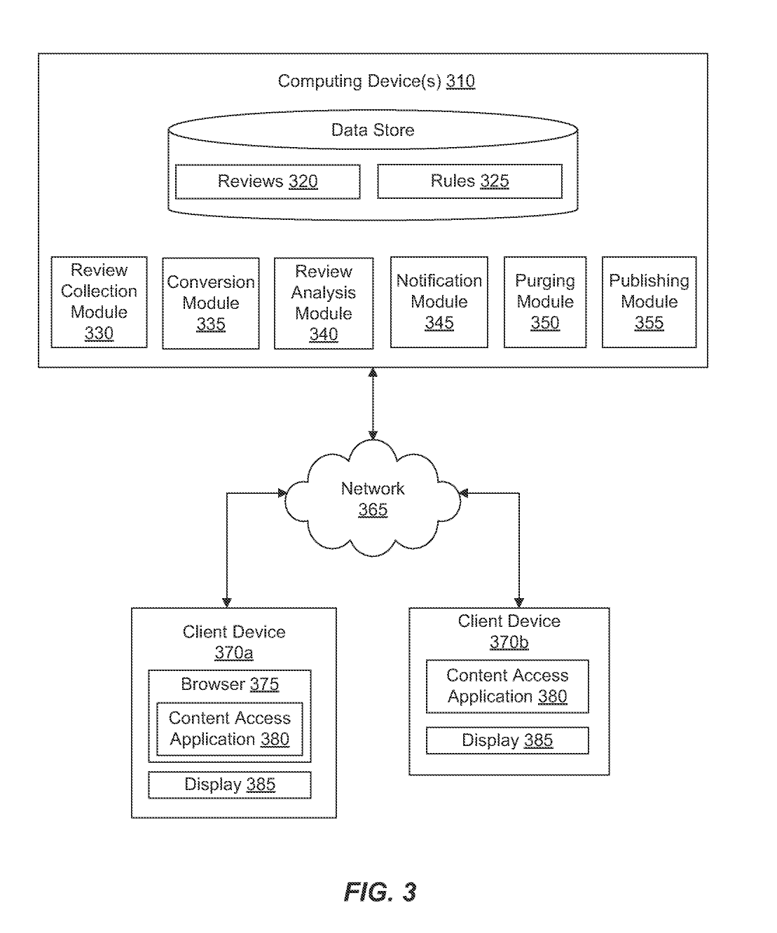

Referring to FIG. 3, another example system for managing reviews is illustrated in accordance with an embodiment. The system of FIG. 3 includes a review collection module 330. The review collection module may collect reviews of a service based organization from a closed review system which are based on verified user experiences with the service based organization. In other words, the reviewers have demonstrated use of the service, such as by entering a unique code available on a receipt for purchase of the service. Collected reviews may be stored in a review data store 320. In one aspect, the review collection module may collect reviews from the closed review system for service based organizations having multiple locations of operation. The review collection module may be or include an aggregation module to aggregate the reviews from the closed review system on a per-location basis and assign a score to each of the multiple locations of operation.

The system may include a conversion module 335. The conversion module may convert the reviews in the review data store from the closed review system into converted reviews. The converted reviews may be proximal in time to a current time, within a predetermined threshold and may be greater in number than a number of reviews for the same time period available on an open review system. The conversion module may convert reviews in any suitable manner and to or from any suitable format or type of review. For example, the conversion module may extract text from freeform text input received from a user. As another example, the conversion module may summarize the reviews from the closed review system for publication to the open review system as summarized reviews. As another example, the conversion module may convert a scale rating of the reviews from the closed review system to a scale rating for the open review system. As another example, the conversion module may convert text of the reviews from the closed review system to a scale rating for the open review system. Any number of other conversions may also be performed.

The system may include a review analysis module 340. The review analysis module may identify misrepresentative reviews of a service based organization sourced from an open review system. Rather than identifying an individual review, the review analysis module may evaluate an aggregate of reviews and determine, for example, whether the reviews are proximal in time or how many reviews are available. The misrepresentative reviews may be generally positive or negative, but may be considered misrepresentative due to age or number of reviews. The review analysis module may follow rules stored in a rule data store to determine whether the open review system reviews are sufficiently large in number or sufficiently proximal in time to be representative or misrepresentative. The review analysis module may include an application programming interface (API) for accessing the open review system, such as a social network, social review, public review network page, etc.

The system may include a notification module 345. The notification module may provide a notification for display on the open review system to notify users of the open review system when the converted reviews have been published to the open review system. In other words, users of the open review system may be put on notice that some of the reviews on the open review system were sourced from somewhere other than the open review system. The notice may be included or associated with individual reviews, or may be displayed as a general notice to users visiting an open review website, or may be provided in association with organizations reviewed on the open review website that include reviews published from a closed review system.

The system may include a purging module 350. The purging module may be used to purge the old reviews from the open or closed review systems when a date of the reviews is outside of a predetermined time period from the present, for example.

The system may include a publishing module 355. The publishing module may be used to publish the converted reviews to the open review system. In one example, the publishing module publishes the converted reviews when a number of the reviews from the closed review system is greater than a predetermined threshold number higher than a number of the misrepresentative reviews from the open review system, the reviews from the open review system being misrepresentative due to number of reviews, age of the reviews and so forth.

The computing device(s) 310 on which the system operates may include a server. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The media content stored by the media storage module may be video content, audio content, image content, text content or another type of media content, particularly such as may be included in a review of an organization.

Client devices 370a-370b may access data, content pages, content items and so forth via the computing device 310 over a network 365. Example client devices may include, but are not limited to, a desktop computer, a laptop, a tablet, a mobile device, a television, a cell phone, a smart phone, a hand held messaging device, a set-top box, a gaming console, a personal data assistant, an electronic book reader, heads up display (HUD) glasses, a car navigation system, or any device with a display 385 that may receive and present the media content.

Users may also be identified via various methods, such as a unique login and password, a unique authentication method, an Internet Protocol (IP) address of the user's computer, an HTTP (Hyper Text Transfer Protocol) cookie, a GPS (Global Positioning System) coordinate, or using similar identification methods. A user may have an account with the server, service or provider, which may optionally track purchase history, viewing history, store user preferences and profile information and so forth.

The system may be implemented across one or more computing device(s) 310, 370a, 370b connected via a network 365. For example, a computing device 310 may include one or more of the data stores 320, 325 and various engines and/or modules such as those described above and such modules may be executable by a processor of the computing device 310.

The modules that have been described may be stored on, accessed by, accessed through, or executed by a computing device 310. The computing device may comprise, for example, a server computer or any other system providing computing capability. Alternatively, a plurality of computing devices may be employed that are arranged, for example, in one or more server banks, blade servers or other arrangements. For example, a plurality of computing devices together may comprise a clustered computing resource, a grid computing resource, and/or any other distributed computing arrangement. Such computing devices may be located in a single installation or may be distributed among many different geographical locations. For purposes of convenience, the computing device is referred to herein in the singular form. Even though the computing device is referred to in the singular form, however, it is understood that a plurality of computing devices may be employed in the various arrangements described above.

Various applications and/or other functionality may be executed in the computing device 410 according to various embodiments, which applications and/or functionality may be represented at least in part by the modules that have been described. Also, various data may be stored in a data store that is accessible to the computing device. The data store may be representative of a plurality of data stores as may be appreciated. The data stored in the data store, for example, may be associated with the operation of the various applications and/or functional entities described. The components executed on the computing device may include the modules described, as well as various other applications, services, processes, systems, engines or functionality not discussed in detail herein.

The client devices 370a, 370b shown in FIG. 3 are representative of a plurality of client devices that may be coupled to the network. The client devices may communicate with the computing device over any appropriate network, including an intranet, the Internet, a cellular network, a local area network (LAN), a wide area network (WAN), a wireless data network or a similar network or combination of networks.

Each client device 370a, 370b may include a respective display 385. The display may comprise, for example, one or more devices such as cathode ray tubes (CRTs), liquid crystal display (LCD) screens, gas plasma based flat panel displays, LCD projectors, or other types of display devices, etc.

Each client device 370a, 370b may be configured to execute various applications such as a browser 375, a respective page or content access application 380 for an online retail store and/or other applications. The browser may be executed in a client device, for example, to access and render content pages, such as web pages or other network content served up by the computing device 310 and/or other servers. The content access application is executed to obtain and render for display content features from the server or computing device, or other services and/or local storage media.

In some embodiments, the content access application 380 may correspond to code that is executed in the browser 375 or plug-ins to the browser. In other embodiments, the content access application may correspond to a standalone application, such as a mobile application. The client device 370a, 370b may be configured to execute applications beyond those mentioned above, such as, for example, mobile applications, email applications, instant message applications and/or other applications. Users at client devices may access content features through content display devices or through content access applications 380 executed in the client devices.

Although a specific structure may be described herein that defines server-side roles (e.g., of content delivery service) and client-side roles (e.g., of the content access application), it is understood that various functions may be performed at the server side or the client side.

Certain processing modules may be discussed in connection with this technology. In one example configuration, a module may be considered a service with one or more processes executing on a server or other computer hardware. Such services may be centrally hosted functionality or a service application that may receive requests and provide output to other services or customer devices. For example, modules providing services may be considered on-demand computing that is hosted in a server, cloud, grid or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed, such as for accessing the closed reviews.

Broadly, in accordance with one embodiment of the invention, reviews that have been collected and processed from the closed review system are published alongside reviews from an open review system. More specifically, an organization having one or more reviews on an open review system may selectively target open review sites that rate the organization using any number of search engines or Internet search programs. Equipped with more accurate, reliable closed review data, reviews from closed review survey may be posted on the open review system. For example, if the open review system provided ratings based on a total number of stars (e.g., 5 stars being the greatest possible score) a closed review rating could be normalized to that rating system. An organization that received an overall converted rating of 4 out of 5 stars from the closed review survey would receive a post indicating that the “consumer” gave the organization 4 out of 5 stars. The name of “consumer” entering the public review would be identified as Mindshare Trusted Review™ or some other company indicator that would educate the reader that the review was not that of an alleged regular consumer. Where comments associated with the review are allowed, an explanation of regarding the process used is provided. For example, the comment could state that the review was based off of a normalized rating of 1,354 verified consumers that were serviced at the referenced organization within the last year. In this manner, public review websites receive a “corrected” score that may be relied upon by those who look at consumer ratings and investigate comments associated with the ratings.

Alternatively, a website may be provided that is entitled Mindshare Trusted Review™ (or some other alternative indicator of source) that provides closed-review ratings as discussed herein. The closed review ratings are accompanied by a section entitled public review ratings or open review ratings that includes links to public review websites regarding an organization appearing on the “trusted review” site with an explanation of the differences between rating systems and comparing and contrasting the different reviews.

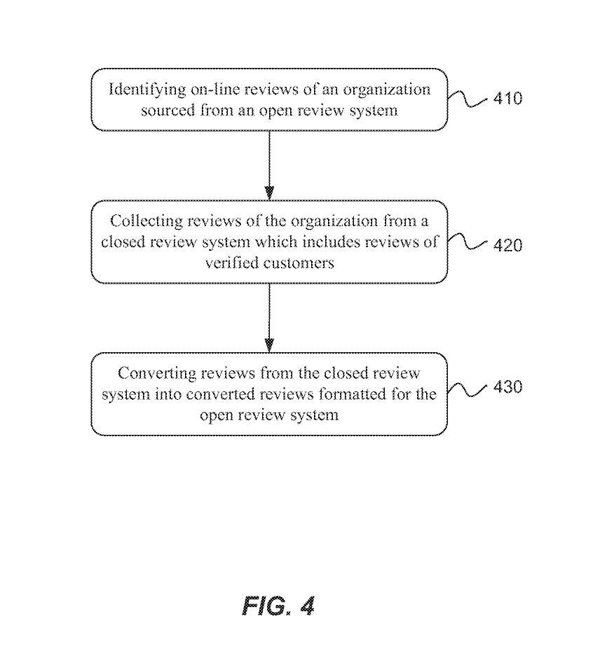

Referring now to FIG. 4, a flow diagram of a method for managing reviews of organizations is illustrated in accordance with an example of the present technology. The method may include identifying 410 on-line reviews of an organization sourced from an open review system and collecting 420 reviews of the organization from a closed review system. The reviews from the closed review system may be submitted by organization customers within a predefined period of time prior to a current time and the number of reviews may exceed a predetermined amount of reviews. The method may include converting 430 reviews from the closed review system into converted reviews formatted for the open review system.

In a more specific implementation, a user may leave a review using the closed review system. The review may include multiple ratings, including a primary or overall rating. The primary rating may be converted to a common, consistent, and comparable rating system (e.g. a rating on a scale of 1 to 10 is converted to a “5 star” rating). The text of the review may be analyzed to lift out a common set of predetermined categories. In other words, text related to categories such as taste, quality, service, value and so forth may be extracted and associated with the respective categories. The reviews of many users can be aggregated and analyzed on a per-location (business unit, store, agent, etc.) or may optionally be aggregated at higher levels than the location. The transformed or converted scores and summary of the reviews may be displayed on a public website. The public website may be for displaying the closed reviews or may be the open review website. Users may be enabled to view the aggregate and individual reviews to assist in making a decision of which organization or location to visit.

Privately gathered survey or review data may be collected for the purposes of operational improvement in a multi-location business (fast food, hotel, car rental, call center, etc.). On a per-location basis the information may be aggregated and re-scored in a consistent way. Common shared facts about the survey data may be extracted through both structured analysis and unstructured text analysis. This information may be made available as a public report card for the location.

The information may be structured and transformed for the specific purpose of improving a brand's public image by leveraging other information outlets. The aggregate information, along with the detail information is submitted for further aggregation and indexing by public information sources, social networks, open review sites and the like.

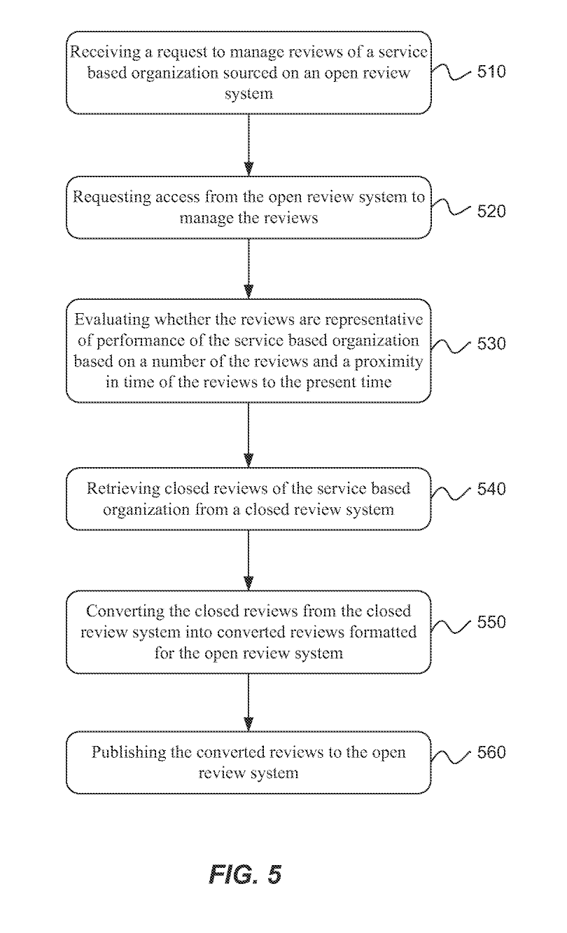

Referring to FIG. 5, a flow diagram of another method for managing reviews of service based organizations is illustrated in accordance with an example. The method may include receiving 510 a request to manage reviews of a service based organization sourced on an open review system and requesting 520 access from the open review system to manage the reviews. The method may include evaluating 530 whether the reviews are representative of performance of the service based organization based on a number of the reviews and a proximity in time of the reviews to the present time. Based on the evaluation, the method may include retrieving 540 closed reviews of the service based organization from a closed review system and publishing 560 the reviews to the open review system. The method may include converting 550 the closed reviews from the closed review system into converted reviews formatted for the open review system when the reviews are proximal in time to a current time, within a predetermined threshold. The reviews published to the open review system may be the converted reviews.

The closed review system may gather thousands of surveys or reviews per year for individual locations or organizations. In contrast public review sites and social media may gather significantly fewer reviews. As a result, the reviews from the closed review system may correctly represent the real public opinion of a location or organization, whereas public review sites may have been disproportionately visited by upset customers wanting to vent or make an impact based on their negative experience.

As a result of the high volume of reviews produced by the closed review system, survey data may be constantly and consistently fresh and changing, which may be particularly valuable for the service industry where an entire staff may change each season. Open review sites are often largely static, with a small number of reviews posted each year which do not reflect the dynamically changing service industry.

Because the closed review system reviews are collected after a verifiable transaction has occurred, the potential for fraudulent reviews may be greatly reduced. Public, open review sites may commonly encounter fraud because of anonymity, lack of enforcement of policies, no requirement for verification of valid transactions prior to leaving a review, and so forth.

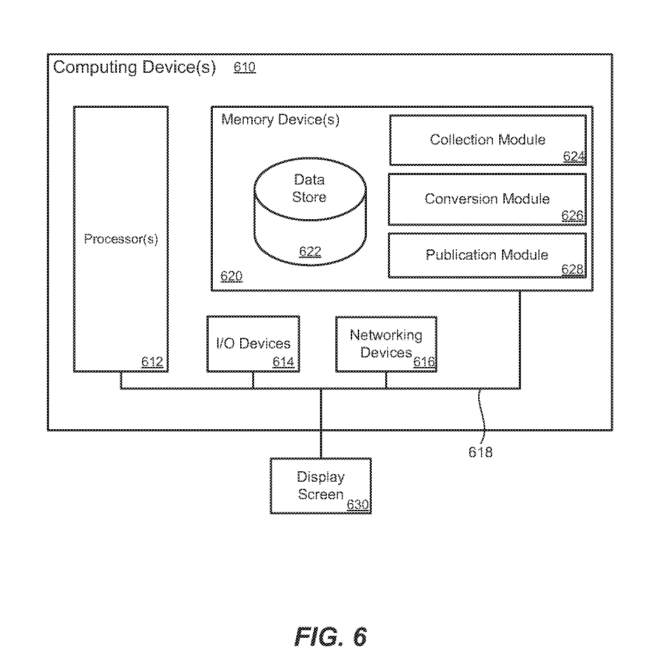

FIG. 6 illustrates a computing device 610 on which modules of this technology may execute. A computing device is illustrated on which a high level example of the technology may be executed. The computing device may include one or more processors 612 that are in communication with memory devices 620. The computing device may include a local communication interface 618 for the components in the computing device. For example, the local communication interface may be a local data bus and/or any related address or control busses as may be desired.

The memory device 620 may contain modules that are executable by the processor(s) 612 and data for the modules. Located in the memory device 620 are modules executable by the processor. For example, a collection module 624, conversion module 626, and publication module 628, and other modules may be located in the memory device. The modules may execute the functions described earlier. A data store 622 may also be located in the memory device 620 for storing data related to the modules and other applications along with an operating system that is executable by the processor(s).

Other applications may also be stored in the memory device 620 and may be executable by the processor(s) 612. Components or modules discussed in this description that may be implemented in the form of software using high programming level languages that are compiled, interpreted or executed using a hybrid of the methods.

The computing device may also have access to I/O (input/output) devices 614 that are usable by the computing devices. An example of an I/O device is a display screen 630 that is available to display output from the computing devices. Other known I/O device may be used with the computing device as desired. Networking devices 616 and similar communication devices may be included in the computing device. The networking devices may be wired or wireless networking devices that connect to the internet, a LAN, WAN, or other computing network.

The components or modules that are shown as being stored in the memory device 620 may be executed by the processor 612. The term “executable” may mean a program file that is in a form that may be executed by a processor. For example, a program in a higher level language may be compiled into machine code in a format that may be loaded into a random access portion of the memory device and executed by the processor, or source code may be loaded by another executable program and interpreted to generate instructions in a random access portion of the memory to be executed by a processor. The executable program may be stored in any portion or component of the memory device. For example, the memory device may be random access memory (RAM), read only memory (ROM), flash memory, a solid state drive, memory card, a hard drive, optical disk, floppy disk, magnetic tape, or any other memory components.

The processor 612 may represent multiple processors and the memory 620 may represent multiple memory units that operate in parallel to the processing circuits. This may provide parallel processing channels for the processes and data in the system. The local interface 618 may be used as a network to facilitate communication between any of the multiple processors and multiple memories. The local interface 618 may use additional systems designed for coordinating communication such as load balancing, bulk data transfer, and similar systems.

Throughout the systems and methods heretofore described, transformation or conversion of a review, rating, scoring, etc. has been described as useful. Because different organizations in different locations, which may have been reviewed using different review mechanisms, may be compared, and more particularly may be compared with scores, ratings, reviews and so forth from different review systems, such as open review systems. As a result of the conversion, the scores may be common, consistent, and comparable. A description of the conversion or transformation process follows below.

Customer satisfaction data can be obtained from multiple disparate data sources, including in-store consumer surveys, post-sale online surveys, voice surveys, comment cards, social media, imported CRM data, and broader open market consumer polling, for example.

Several factors are included in determining a composite score or numerical representation of customer satisfaction. Herein, that numeral representation is referred to as a Customer Satisfaction Index (“CSI”) or Primary Performance Indicator (“PPI”). There are a number of other methods for deriving a composite numerical representation of customer satisfaction that are contemplated for use in different embodiments of the present invention. For example, Net Promotor Score (NPS), Guest Loyalty Index (GSI), Overall Satisfaction (OSAT), Top Box, etc. are contemplated for use herein. This list is not exhaustive and many other methods exist to use mathematical methods to derive a numeric representation of satisfaction or loyalty would be apparent for use herein by one ordinary skill in the art. One object of the present invention is to determine optimal actions to increase the CSI for a particular situation. Data retrieved from customer feedback sources ranking their satisfaction with a particular service or product is compiled and used to calculate an aggregate score.

The activities which will most likely have the greatest influence on the CSI, referred to as key drivers herein, are determined. Key driver analysis includes correlation, importance/performance mapping, and regression techniques. These techniques use historical data to mathematically demonstrate a link between the CSI (the dependent variable) and the key drivers (independent variables). Many of these techniques, however, include an inherent bias in that the analysis may not coincide with intuitive management decision-making. That is, key drivers that consistently show as needing the most improvement may not greatly increase the overall CSI. For example, the quality of food at a hospital may have a consistent low ranking on customer satisfaction feedback. However, that may not have any effect on a customer's decision to return to that hospital for his or her healthcare needs. The key is providing a prediction of which key driver will most likely increase overall CSI if that key driver is improved.

Key drivers may both increase and decrease the CSI, or both, depending on the particular driver. For example, if a bathroom is not clean, customers may give significantly lower CSI ratings. However, the same consumers may not provide significantly higher CSI ratings once the bathroom reaches a threshold level of cleanliness. That is, certain key drivers provide a diminishing rate of return. Other drivers may also be evaluated but that do not have a significant impact on CSI. For example, a restaurant may require the use of uniforms in order to convey a desired brand image. Although brand image may be very important to the business, it may not drive customer satisfaction and may be difficult to analyze statistically.

Once a CSI is determined and key drivers are identified, the importance of each key driver with respect to incremental improvements on the CSI is determined. That is, if drivers were rated from 1 to 5, moving an individual driver (e.g., quality) from a 2 to a 3 may be more important to the overall CSI than moving an individual driver (e.g., speed) from a 1 to a 2. When potential incremental improvement is estimated, key driver ratings for surveys are evaluated to determine the net change in the CSI based on incremental changes (either positive or negative) to key drivers. In one embodiment, once all of the surveys' CSI have been recomputed for each driver, the list of drivers is sorted by average improvement. In another embodiment, key driver values are selected based on an optimized CSI. That optimization may be determined with or without respect to cost of implementation.

Specific actions necessary to incrementally modify the key drivers are determined after an optimum key driver scheme is determined. Those actions, referred to as specific or standard operating procedures (“SOPs”), describe a particular remedial step connected with improving each driver, optimizing profit while maintaining a current CSI, or incrementally adjusting CSI to achieve a desired profit margin. In short, the SOPs constitute a set of user specified recommendations that will ultimately be provided via the system and method described herein to improve the CSI score.

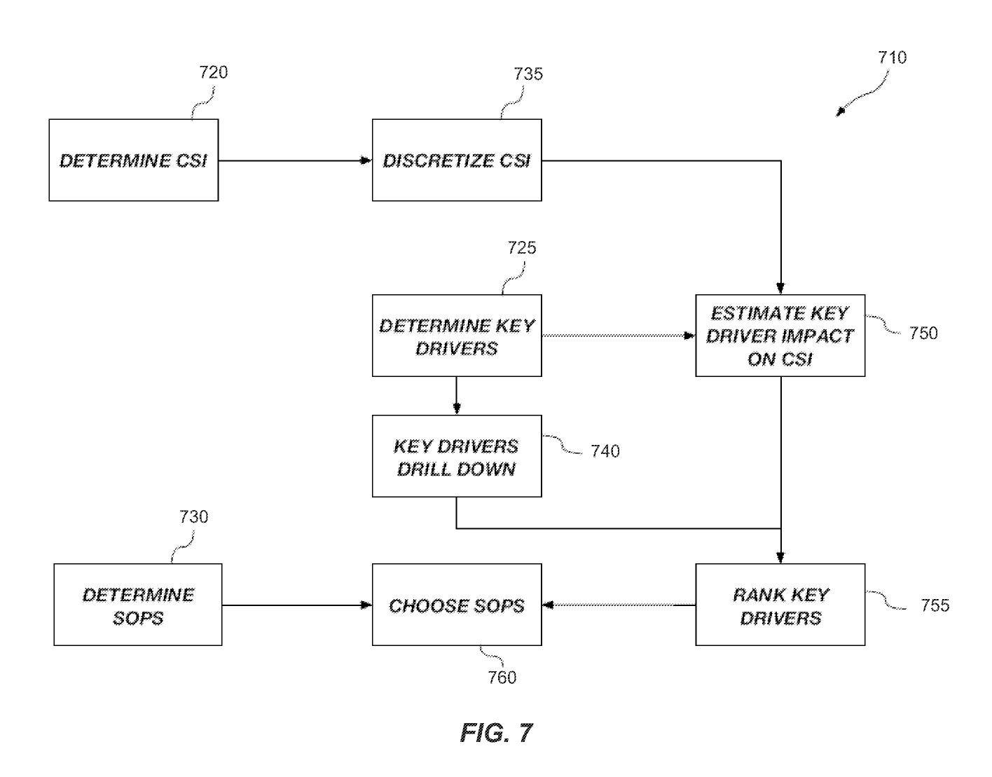

FIG. 7 illustrates a block diagram illustration of certain blocks of the recommendation engine 710 described herein. At 720, a CSI is determined from relevant customer feedback information which has been provided from any number of sources and in any number of forms. For example, a survey may ask a consumer to rank a particular product from 1 to 10, or may ask a consumer to rank a service as poor, fair, good, or superior. In order to measure improvement to CSI, CSI scores are normalized and then discretized (shown at 35) into a predetermined range of numbers that fall between a predetermined minimum and maximum score. For example, if a CSI were normalized to a 100 point scale, it might be discretized into four groups or bins (0-25, 26-50, 50-75, and 76-100). Alternatively, it could be discretized into groups of five or ten, depending on the overall distribution of survey scores. In yet another example, CSI scores may be normalized simply as 1, 2, 3, 4, and 5. The discretization scheme is governed by the desire to model realistic improvements to the CSI in numerically meaningful increments.

In one aspect of the invention, the CSI is derived from one or more numeric data points such as a customer response to the question “Rate your intent to recommend us on a scale of 1 to 5,” or “Rate your overall satisfaction on a scale of 1 to 5”. CSI can also be derived from numeric data points discovered through data analysis such as text analytics. A mathematical formula such as a weighted average is used to compile the components into a single numeric value. For example, the CSI score for a sample (or survey) can comprise average ratings on satisfaction, intent to recommend, and intent to return. Rating questions of this kind are ordinal data points (as opposed to cardinal, nominal, or interval data points) in that they represent discrete values that have a specific directional order.

In accordance with one embodiment of the present invention, the CSI (or other key score) is chosen as the quantity to be optimized (i.e., the dependent variable). Other data points, including key drivers, are independent variables having properties that influence the dependent variable.

Referring now to call-out number 725, key drivers, the independent variables having the greatest influence on the CSI (other key score) are determined and input into the process matrix. Examples of key drivers may include quality, service, atmosphere, and speed. These examples, however, are non-exhaustive and are subject to modification based on a business unit's particular needs and business goals. Similar to the rating questions, key drivers are also ordinal data points. They describe operational areas of improvement which can be tailored to each business unit's needs. An example of a key driver data set with example CSI scores is shown below in Table 1.

TABLE 1
Example Key Driver Data

| Sample # | CSI | Quality | Service | Atmosphere | Speed |
|---|---|---|---|---|---|
| 1 | 73.2 | 5 | 4 | 3 | 4 |
| 2 | 60.5 | 3 | 4 | 3 | 3 |
| 3 | 80.0 | 5 | 4 | 4 | 5 |

In one aspect of the invention, the independent variable data set may comprise additional explanatory properties referred to as key driver drill down data that further describe the ratings of each key driver. For example, a “Vehicle Cleanliness” key driver might have an explanatory property referred to as “Cleanliness Rating Explanation” with possible values including “exterior condition,” “interior condition,” and “interior door.” In one embodiment of the invention the drill down data comprises nominal data within the optimization engine as the data comprises textual labels that have no inherent numerical value or order. In another embodiment, the drill down data is given a numerical value to assist in the possible analysis of drill down data recommendation. An example of key driver drill down data is provided below in Table 2.

TABLE 2
Example Drill Down Data

| | | | Quality Drill | | Speed Drill |
|---|---|---|---|---|---|
| Sample # | CSI | Quality | Down | Speed | Down |
| 1 | 73.2 | 5 | [none] | 3 | Time to order |
| 2 | 60.5 | 3 | Food temp | 3 | Wait time |
| 3 | 40.0 | 2 | Food taste | 4 | [none] |

Each key driver represents an area of possible improvement of the CSI. Drill down properties, shown at numeral 735 on FIG. 7, comprise a subset of each key driver and provide the user with additional information regarding areas of focus related to the key driver itself. Each individual category from the drill down properties is considered separately. The number of times each category was chosen by the model as the drill down reason is then computed from the rows in the data set. All the drill down categories are then ranked by one of several ranking algorithms (most often occurring, marketing directives, cost adjusted occurrence, etc.). That is, while not required in certain embodiments of the invention, the drill down data is useful in selecting specified operational procedures to improve the ranking of the key driver and thus improve the overall CSI.

Specified or standard operational procedures (“SOPs”), shown at numeral 730 on FIG. 7, comprise textual entries representing an action that should be taken in response to a system recommendation. SOPs are determined and entered individually for each user as suits a particular business application. An SOP data set can contain recommendation text for key drivers or individual key-driver drill down. An example SOP data set is shown below in Table 3.

TABLE 3
Example SOP Data Set

| Key Driver | Drill Down | SOP |
|---|---|---|
| Cleanliness | [none] | Inspect work area for clutter and debris |
| | | Check storefront entryway |
| Cleanliness | Waiting or | Ensure product shelves are organized and |
| | retail area | free of dust |
| | | Inspect flooring, chairs, windows, and |
| | | shelves |
| Cleanliness | Stylist | Ensure hair has been vacuumed after each |
| | station | customer visit |
| | | Check sinks and countertops for organization |
| | | and debris accumulation |

Operational improvement analysis can be performed for any sized business and at any level of organization. In one embodiment of the invention, operational improvement recommendations are made for individual business units such as a single store, restaurant, or hotel. In another embodiment, recommendations are made for aggregate business units and can be made by region, state, country, etc. In one aspect of the invention, recommendations by way of comparison with other similar business units referred to as a peer comparison unit. An example peer comparison comprises a comparison of a single retail store against the average performance of other stores (individual or select aggregate units) in the region at specific dates and even specific times of day. In another aspect of the invention, business units may be compared to peer business units in different regions to assess differences in effectiveness of SOPs and/or key driver improvement implemented in different regions. For example, customer loyalty may be less affected in the southern part of the United States by improvement in certain key drivers for the same retail establishment in the northwest. Likewise, certain SOPs may have less of an effect on improving key drivers in the Canada as they may have in Mexico. Advantageously, the peer comparison analysis permits an owner of retail establishments spanning a broad territory to customize and analyze the effectiveness of a customer loyalty improvement scheme. As noted above, recommendations are made for operational improvement based on how the performance of independent key driver influences the CSI. However, while key driver performance may be a primary metric in one embodiment, other embodiments include analysis of specific key driver metrics such as the ability of key driver's to influence the CSI or PPI, key driver consistency, peer comparison, costs, and profitability, for example, each of which can be used as independent variables.

In one embodiment of the invention, the recommendation engine 710 can be configured by determining a target value or prioritized mix between factors or key driver metrics to be optimized. In one embodiment, this is achieved by allocating points between all of the factors. For example, on a 10 point scale, 5 points may be allocated to performance, 3 to consistency, and 2 to cost, representing a fifty percent priority on performance, thirty percent priority on consistency, and twenty percent for cost, respectively. The target value or priority mix is then converted into a vector quantity yielding an “angle” than can be compared against other calculated angles. A similar vector can be computed for each sample in the customer satisfaction data, allowing aggregate comparisons against the target value. Two dimensions of goal-setting, consistency and performance, for example, may be represented by two points and an angle (i.e., a vector). Three dimensions of goal-setting (e.g., consistency, performance, and cost) may be represented by a three dimensional vector and four dimensional goal-setting by a four dimensional vector and so on.

In one embodiment of the invention, recommendation engine users choose a strategy (e.g., performance and consistency) and allocate 10 points between the two categories resulting in two target vectors. The resulting two target vectors are utilized to assess which key driver, if improved, most aligns with the strategy. An example target vector allocation is shown below in Table 4.

TABLE 4
Customer Target Vector

| | | | Angle | Angle |
|---|---|---|---|---|
| | Performance | Consistency | (Radians) | (Degrees) |
| Strategy 1 | 6 | 4 | 0.5880026 | 33.7 |
| Strategy 2 | 2 | 8 | 1.3258177 | 78.0 |

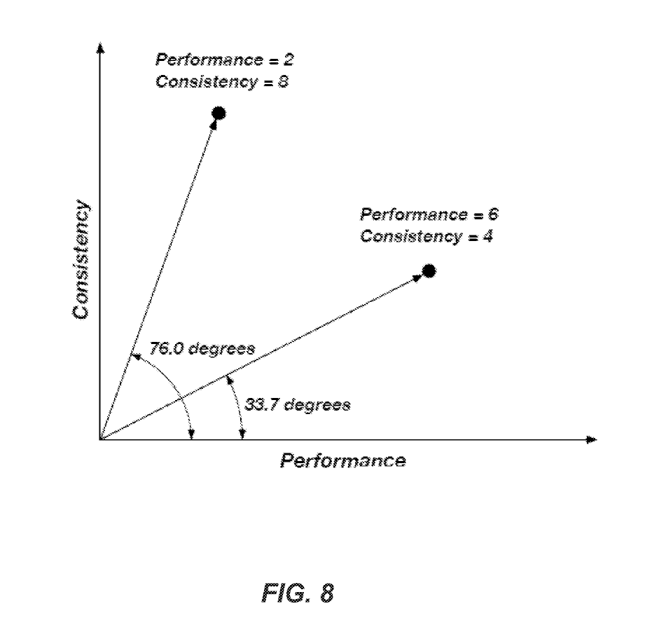

Referring now to FIG. 8, in accordance with one embodiment of the invention, in order to compare vectors together they are normalized by projecting the vector onto a unit sphere which comprises the set of points distance one from a fixed central point. This allows computation of the distance between vectors.

In one embodiment of the invention, ordinal logistic regression analysis is performed to calculate the probability of the target variable (e.g., the CSI) moving up or down by a predetermined level when one single key driver value moves up by a predetermined level. Put plainly, in one aspect of the invention ordinal logistic regression is used to determine which key driver has the highest probability of moving the target variable in the desired direction when one single driver value moves up one level. Here, it is important to note that different target variables are improved by increasing the value and others by decreasing the value, depending on the direction of the ordinal scale utilized to denote improvement. For example, in one embodiment customer satisfaction may be rated on a scale of 1 to 5 with one being poor and 5 being excellent. In another embodiment, 5 may be considered poor and 1 may be considered excellent.

The results of ordinal logistic regression is an array of “intercepts,” one for each dependent variable level, and an array of “parameters,” one for each driver variable level. For example, if the model contained CSI as the dependent variable and two drivers, a Friendliness Rating and a Quality Rating (all three on a five-point scale, e.g.,), the results of an example ordinal logistic regression are presented in Table 5 below.

TABLE 5
Ordinal Logistical Regression Results

| Result Type | Term | Estimate |
|---|---|---|
| Target | Intercept[1] | 4.709 |
| | Intercept[2] | 6.165 |
| | Intercept[3] | 7.964 |
| | Intercept[4] | 10.488 |
| Driver | Friendliness[1-2] | −1.663 |
| | Friendliness[2-3] | −0.693 |
| | Friendliness[3-4] | −0.732 |
| | Friendliness[4-5] | −1.592 |
| Driver | Quality[1-2] | −1.156 |
| | Quality[2-3] | −0.336 |
| | Quality[3-4] | −0.482 |
| | Quality[4-5] | −0.583 |

There is one intercept for each possible value of the target value, except the highest value because it cannot be improved. There is one driver estimate for each possible movement (1 up to 2, 2 up to 3, etc.) in the driver value. In this way an intercept and driver estimate can be determined by finding the Intercept value that matches the target value and a driver estimate that matches the driver's value.

In one aspect of the invention, the probability of the target variable moving up by one when a single driver value moves up by one is represented by the formula:

$$ln \frac{p}{1 - p} = {Intercept}_{Target} + {Driver}_{Value}$$

where p is the probability of moving the target value up one level, Intercept_{Target} is the ordinal logistic intercept result for the target variable level, and Driver_{Value} is the ordinal logistic parameter result for the driver variable level. The ordinal logistic regression results in a set of intercepts and one set of parameter estimates for each key driver. That is, one estimate for each change in level.

Referring back to FIG. 7, for each row in a sample data set (such as that shown in Table 1) the change in the dependent variable score (e.g., the CSI) is predicted based on the movement of each key driver up one level. In one aspect of the invention, shown at numeral 750, this is completed row-by-row in the base data by comparing the value of all of the variables via the following formulas:

N=Intercept_{Target}+Driver_{Target}

where N is an intermediate variable containing the sum of the following two values, Intercept_{Target} is the ordinal logistic regression parameter for the target variable's level, and Driver_{Target} is the ordinal logistic regression parameter for the driver variable level.

$$p = \frac{{e}^{N}}{1 + {e}^{N}}$$

where p is the probability of increasing the target variable; and

Target_{new}=(1−p)Target_{old}+p(Target_{old}+1), if Target_{old}<max max Target, if Target_{old}

where Target_{new} is the possible new value of the target variable if the driver value is increased by one level and Target_{old} is the current value of the target variable (before improvement). Every row of data is recomputed in this manner resulting in a recomputed CSI score as if each driver had been improved by one level. Table 5 below is an example of recomputed CSI values based on improvement of each key driver by one level.

TABLE 5
Recomputed CSI data

| | | | | | | CSI | CS |
|---|---|---|---|---|---|---|---|
| | | | | | | from | from |
| CSI | Intercept | Quality | Quality Param | Friendly | Friendly Param | Quality + 1 | Friendly + 1 |
| 5 | | 5 | | 4 | −1.0097 | 5 | 5 |
| 3 | 7.9651 | 2 | −0.695 | 3 | −0.6129 | 3.99 | 3.99 |
| 1 | 4.7094 | 1 | −1.6643 | 1 | −1.599 | 1.99 | 1.99 |
| 4 | 10.4889 | 4 | −1.2053 | 4 | −1.0097 | 4.99 | 4.99 |

A new set of CSI average scores are now computed for each driver across the entire data set, similar to the baseline average CSI computation, except that the new recomputed “uplifted” score is used (average uplifted score for performance, standard deviation for consistency, ranking for peer comparison, etc.). In other words, for a starting set of samples there will be individual driver ratings and a computed CSI value. The baseline average is the average CSI over the entire set. A “new” CSI is computed as above for each sample. Then a “new” CSI average can be computed, one average for each driver. Example new improvement factor values are shown below in Table 6.

TABLE 6
New Improvement Factor Values

| | Improved CSI Mean | Standard Deviation |
|---|---|---|
| Quality | 3.99952886 | 1.41501436 |
| Friendly | 3.99949644 | 1.41506723 |
| Speed | 3.99923445 | 1.415454 |
| Cleanliness | 3.99863255 | 1.41663918 |
| Order Correctness | 3.49894622 | 1.29262765 |

Each value has its own scale and unit of measurement and thus cannot be directly compared to each other. Accordingly, each value is transformed into a standard z-score, a dimensionless quantity used to compare values. Means are transformed by the following formula as is known in the art:

$$\frac{{μ}_{target} - {μ}_{base}}{{σ}_{base}}$$

Standard deviations are transformed by the following formula as is known in the art:

$$\sqrt{2 n} \frac{{σ}_{base} - {σ}_{target}}{{σ}_{base}}$$

Table 7 below shows an example of standardized key driver values.

TABLE 7
Standardized Key Driver Values

| | Standardized “new” | Standard |
|---|---|---|
| | CSI Mean | Deviation |
| | (Performance) | (Consistency) |
| Quality | 0.438879 | 0.4849407 |
| Friendly | 0.438860 | 0.48485314 |
| Speed | 0.438707 | 0.48406121 |
| Cleanliness | 0.438354 | 0.48224975 |
| Order Correctness | 0.145768 | 0.68763235 |

It is possible that the only desired outcome is to increase the key driver performance with regard to CSI. In this case the driver with the highest “new” CSI is the driver that will most likely increase real CSI. However, in many cases it is desirable to compare improvement in CSI versus another measure such as consistency for example. In this manner, a user is able to “balance” its recommendation based on desired operational outcomes. Consistency is a measure of how closely together samples in the data set perform. For example, many restaurants desire a consistent quality rather than excellent for one customer and poor for the next. In this case a measure of consistency can be added as a dimension of the recommendation. Other examples of key driver metrics might include, but are not limited to, the cost of implementing key drivers or the comparison of other peer operational units.

To use consistency, for example, as an additional measure that influences the recommendation the following steps are added to the process. Once new scores are standardized, an angle is computed for comparison against a target angle (or vector). Using the example factors of performance and consistency, both target and comparison angles would be computed using the following formula:

$$arc tan \frac{Consistency}{Performance}$$

An example of comparison angles for the newly computed key driver scores is presented below in Table 8.

TABLE 8
Comparison Angles

| | Angle | Angle |
|---|---|---|
| | (Radians) | (Degrees) |
| Quality | 0.83521678 | 47.8544 |
| Friendly | 0.83514846 | 47.8505 |
| Speed | 0.83450906 | 47.8139 |
| Cleanliness | 0.83304318 | 47.7299 |
| Order Correctness | 1.36190341 | 78.0314 |

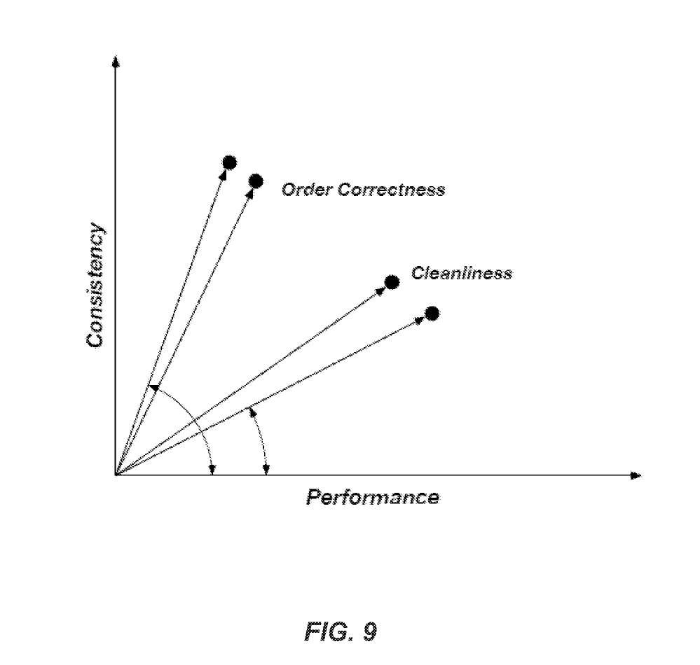

Shown at numeral 755 on FIG. 7, once comparison angles have been determined, the angle of the key driver which most closely aligns with the original target angle is selected. That is, key drivers are ranked based on the distance between its angle and the target angle determined from a particular business strategy. Referring now to FIG. 9, example results showing the two original strategies of performance and consistency is shown. In the upper strategy (i.e., more consistency than performance), order correctness is predicted as having the greatest impact driving the customer satisfaction score. In the lower strategy (i.e., more performance than consistency) cleanliness is identified as the most important key driver. Advantageously, a business manager, or other user of the recommendation engine, may assess and evaluate the resulting effect different key drivers have on variable business strategies.

Additional measures for recommendation can be added into the weighted selection process by adding additional dimensions to the vector. The above example uses performance and consistency as the components of a two-dimensional vector. If cost were an additional consideration, it could be added as another dimension resulting in a three-dimensional vector.

In one embodiment of the invention, for each key driver, there may be one or more “drill-down properties”. A drill-down property is an additional explanatory data point that has been gathered to support the value of the key driver it is linked to. For example, for a key driver called “Vehicle Cleanliness Rating” there may be a nominal drill-down property with possible categorical values such as “exterior,” “interior,” “windows,” and “cargo area.” For an individual sample, the drill-down data explains why the driver rating was selected Each individual category from the drill-down properties is considered separately. The number of times each category was chosen as the drill-down reason is then computed from the rows in the data set. In one aspect, the drill-down categories are ranked by one of several ranking methods as suits a particular business decision. For example, the drill-down categories may be ranked by the most often occurring, marketing directives, cost adjusted occurrence, etc.

Shown at numeral 760, once the appropriate key driver has been identified and any drill-down data evaluated, SOPs are then recommended as the optimal actions for increasing the CSI as shown on Table. 3 above. The SOP library, or recommendation library, can be simple (i.e., limited to one entry per key driver or drill-down category) or very sophisticated (organized by brand hierarchal business unit) depending on a particular business need. In one aspect of the invention, the SOP library lookup is keyed based on brand, hierarchy, key driver, and drill-down category. Businesses may contain one or more brands and within each brand there may be a reporting hierarchy (organization chart) of business units. Each brand and business unit may have unique goals shaped by business type, geography, demographics, etc. For example, a business may have three different types of retail facilities (fast-food restaurant franchises, fast-food delivery services to franchisees, and the preparation and packaging of fast-food products for franchisees). Each of those retail operations might have numerous locations spread out over different parts of the country and each may serve a different demographic. For example, the customers in one locale may be primarily young students attending a local college and the customers in another locale may constitute primarily retirees. Moreover, the retail operations may service business operations in the northeast (i.e., New York, Massachusetts, etc.) or the southwest (i.e., Arizona, Southern California). Each of these variations in demographics and geography, for example, require unique SOPs that are specifically tailored to a particular need.

As a result of the aforementioned need, a custom set of SOP recommendations can be built for each key driver and drill-down category 740 for a given brand, geography, demographic, etc., and then customized for each level in the organizational chart. If no SOP can be found for a drill-down category, or if no drill down category exists, a default key driver recommendation is given. The SOPs can also be keyed according to cost of implementation. In this manner, a business manager can evaluate which SOPs are likely to have the greatest influence on customer satisfaction for the least amount of money.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

In the description herein, details are given to provide an understanding of some embodiments of the present invention. However, it will be understood by one of ordinary skill in the art that the disclosed methods and apparatus may be practiced without the specific details of the example embodiments. It is also noted that certain aspects may be described as a process, which is depicted as a flowchart, a flow diagram, a structure diagram, or a block diagram. Although a flowchart may describe the operations as a sequential process, many of the operations can be performed in parallel or concurrently and the process can be repeated. In addition, the order of operations may be re-arranged.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for managing reviews of organizations, comprising:
identifying on-line reviews of an organization sourced from an open review system, the open review system including reviews of unverified customers;
collecting reviews of the organization from a closed review system which includes reviews of verified customers, wherein the reviews from the closed review system are submitted by organization customers within a predefined period of time prior to a current time and wherein the number of reviews exceeds a predetermined amount of reviews; and
converting reviews from the closed review system into converted reviews formatted for the open review system, using a processor.

2. The method of claim 1, further comprising purging the converted reviews from the open review system when said reviews do not predate the current time by the predefined period of time.

3. The method of claim 1, wherein the predetermined period of time is six months.

4. The method of claim 1, wherein the predetermined period of time is one year.

5. The method of claim 1, wherein the reviews from the closed review system are greater in number than the reviews from the open review system.

6. The method of claim 1, wherein the minimum number closed-system reviews is 1,000.

7. The method of claim 1, wherein the open review system comprises a social network, social review, or public review network page.

8. The method of claim 1, further comprising extracting text from freeform text input received from a user.

9. The method of claim 1, further comprising summarizing the reviews from the closed review system and publishing the summarized reviews to the open review system.

10. The method of claim 1, wherein converting the reviews comprises converting a scale rating of the reviews from the closed review system to a scale rating for the open review system.

11. The method of claim 1, wherein converting the reviews comprises converting text of the reviews from the closed review system to a scale rating and publishing said scale rating to the open review system.

12. The method of claim 1, wherein converting the reviews comprises converting text of the reviews from the closed review system to text for the open review system.

13. The method of claim 1, further comprising collecting reviews from the closed review system for organizations having multiple locations of operation, the method further comprising aggregating the reviews from the closed review system on a per-location basis and assigning a score to each of the multiple locations of operation.

14. A system for managing reviews of service based organizations, comprising:
a review collection module to collect reviews of a service based organization from a closed review system which includes reviews of verified customers of the service based organization, the reviews being based on verified user experiences with the service based organization;
a conversion module to convert the reviews from the closed review system into converted reviews using a processor, when the reviews are proximal in time to a current time, within a predetermined threshold; and
wherein the reviews from the closed review system are submitted by organization customers within a predefined period of time prior to a current time and wherein the number of reviews exceeds a predetermined amount of reviews.

15. The system of claim 14, further comprising a review analysis module to identify misrepresentative reviews of the service based organization sourced from an open review system including reviews of unverified customers of the service based organization.

16. The system of claim 14, further comprising a notification module to provide a notification for display on the open review system to notify users of the open review system when the converted reviews have been published to an open review system.

17. The system of claim 14, further comprising a purging module to purge old reviews from the closed review system or from an open review system when the reviews are outside of a predefined period of time prior to a current time.

18. The system of claim 14, wherein the publishing module publishes the converted reviews to the open review system when a number of the reviews from the closed review system is greater than a predetermined threshold number higher than a number of the misrepresentative reviews from the open review system.

19. The system of claim 14, wherein review analysis module comprises an application programming interface (API) for accessing the open review system, and the open review system comprises a social network, social review, or public review network page.

20. The system of claim 14, wherein the conversion module:
extracts text from freeform text input received from a user;
summarizes the reviews from the closed review system for publication to the open review system as summarized reviews;
converts a scale rating of the reviews from the closed review system to a scale rating for the open review system; or
converts text of the reviews from the closed review system to a scale rating for the open review system.

21. The system of claim 14, wherein the review collection module collects reviews from the closed review system for service based organizations having multiple locations of operation, the system further comprising an aggregation module to aggregate the reviews from the closed review system on a per-location basis and assign a score to each of the multiple locations of operation.

22. A method for managing reviews of service based organizations, comprising:
evaluating whether reviews from an open review system are representative of performance of the service based organization based on a number of the reviews and a proximity in time of the reviews to the present time, using a processor;
retrieving closed reviews of the service based organization from a closed review system;
converting the closed reviews from the closed review system into converted reviews formatted for the open review system, using the processor, when the reviews are proximal in time to a current time, within a predetermined threshold; and
publishing the converted reviews to the open review system.

23. The method of claim 22, wherein the method is implemented as computer readable program code executed by the processor, the computer readable code being embodied on a non-transitory computer usable medium.

24. The method of claim 22, further comprising publishing a name of the reviewer to the open review system wherein the name of the entity providing the review to the open review system is indicative of the source of the converted closed system review.

25. The method of claim 24, further comprising the step of populating a comment box within the open review system with information regarding the data retrieved from the closed review system used to created the converted review.
